(19) United States
(12) Patent Application Publication
(10) Pub. No.: US 2014/0171061 A1
(43) Pub. Date: Jun. 19, 2014

(54) NETWORK ACCESS DELAY FOR EAB-CONFIGURED UES AND/OR GROUP-BASED ADDRESSED UES

(71) Applicants: Anna Larmo, Espoo (FI); Konstantinos Dimou, Stockholm (SE); Riikka Susitaival, Helsinki (FI); Jose Luis Pradas, Jorvas (FI); Jari Arkko, Kauniainen (FI)

(72) Inventors: Anna Larmo, Espoo (FI); Konstantinos Dimou, Stockholm (SE); Riikka Susitaival, Helsinki (FI); Jose Luis Pradas, Jorvas (FI); Jari Arkko, Kauniainen (FI)

(73) Assignee: TELEFONAKTIEBOLAGET L M ERICSSON (publ), Stockholm (SE)

(21) Appl. No.: 13/517,386

(22) PCT Filed: May 22, 2012
(86) PCT No.: PCT/SE12/50549

§ 371 Date: Jun. 20, 2012

Related U.S. Application Data
(60) Provisional application No. 61/523,737, filed on Aug. 15, 2011.
(60) Provisional application No. 61/558,684, filed on Nov. 11, 2011.

(51) Int. Cl. H04W 48/18

(52) U.S. Cl. CPC H04W 48/18
USPC 455/422.1

(57) ABSTRACT

The access of a user equipment, UE, (10) configured for and activated to implement extended access barring, EAB, or included in a group of UEs addressed via group paging to a wireless communication network (20) is controlled. First, an access delay for the UE is determined. Second, a timing of an attempt by the UE to access a cell in the wireless communication network is controlled based on the determined access delay. Many example embodiments are described.

### TECHNICAL FIELD

The technical field pertains to telecommunications, and particularly to mobile systems such as UMTS terrestrial radio access network (UTRAN) and the evolved UTRAN (E-UTRAN).

### BACKGROUND

In a typical cellular radio system, wireless terminals, also known as mobile stations and/or user equipments (UEs), communicate via a radio access network (RAN) to one or more core networks. The radio access network covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station equipment at a base station site. Each cell is identified by an identity within the local radio area, which is broadcast in the cell. Another identity identifying the cell uniquely in the whole mobile network is also broadcasted in the cell. The base stations communicate over the air interface operating on radio frequencies with the user equipment units (UE) within range of the base stations.

In some versions of the radio access network, several base stations are typically connected, e.g., by landlines or microwave, to a controller node, such as a radio network controller (RNC) or a base station controller (BSC), which supervises and coordinates various activities of the plural base stations connected thereto. The radio network controllers are typically connected to one or more core networks.

The Universal Mobile Telecommunications System (UMTS) is a third generation mobile communication system, which evolved from the second generation (2G) Global System for Mobile Communications (GSM). The UMTS terrestrial radio access network (UTRAN) is essentially a radio access network using wideband code division multiple access for user equipment units (UEs). In a forum known as the Third Generation Partnership Project (3GPP), telecommunications suppliers propose and agree upon standards for third generation networks and UTRAN specifically, and investigate enhanced data rate and radio capacity. Specifications for the Evolved Packet System (EPS) have completed within the 3^{rd} Generation Partnership Project (3GPP) and this work continues in the coming 3GPP releases. The EPS comprises the Evolved Universal Terrestrial Radio Access Network (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio base station nodes are directly connected to the EPC core network rather than to radio network controller (RNC) nodes. In general, in E-UTRAN/LTE the functions of a radio network controller (RNC) node are distributed between the radio base stations nodes, e.g., eNodeBs in LTE, and the core network. As such, the radio access network (RAN) of an EPS system has an essentially “flat” architecture comprising radio base station nodes without reporting to radio network controller (RNC) nodes.

3GPP 22.011, incorporated herein by reference, describes Access Control (AC) in Chapter 4 for mobile terminals in a network. Under certain circumstances, it is necessary to prevent user equipments (UEs) in a mobile network from accessing the network. In the E-UTRAN, AC is necessary to vary the probability of terminals accessing the network for the purposes of (a) congestion control, (b) access control, (c) service differentiation, (d) emergency situations, and/or (3) other special situations such as PLMN failure.

In 3GPP 22.011, all UEs are members of one out of ten randomly allocated mobile populations, defined as Access Classes 0 to 9. The population number is stored in the subscriber identity module or universal subscriber identity module (SIM/USIM, respectively). In addition, UEs may be members of one or more out of 5 special categories (Access Classes 11 to 15), also held in the SIM/USIM. These are allocated to specific high priority users.

Access Class Barring (ACB) is used to control the access attempts of UEs belonging to all of the above access classes. Normal ACs 0-9 are controlled with one set of parameters, and UEs belonging to the special classes 11-15 are higher priority than their normal class, with special ACB parameters overriding the ACB applied to the normal classes 0-9.

In UTRAN, the existing Access Class Barring (ACB) mechanism is based on a bitmap broadcasted by the network. The bitmap indicates which of classes from 0 to 9 are barred and which are not. There is an AccessClassBarred IE per access class in specification 3GPP TS 25.331, incorporated herein by reference in its entirety.

In E-UTRAN, the Access Class Barring (ACB) mechanism is based on an access barring factor and an access barring time, both of which are broadcasted in the system information when ACB is applicable. When ACB is used, UEs attempting access will first draw a uniform random number and compare it against the access barring factor to determine whether access is barred or not. A value lower than the access barring factor denotes that the UE is barred, otherwise access is allowed. If barred, the UE proceeds to determine the time the barring is applicable. Here the access barring time is used as is described in Chapter 5.3.3.11 of 3GPP TS 22.011.

3GPP TS 22.011 also describes Service Specific Access Control (SSAC) for MMTel functions. MMTEL, or Multimedia Telephony, is a specification from the 3GPP Release 7 that enables Session Initiation Protocol (SIP) to be used to deliver presence and IP multimedia services. The purpose is to apply independent access control for telephony services (MMTEL) for mobile originating session requests from idle-mode as follows: The evolved packet system (EPS) shall provide a capability to assign a service probability factor and mean duration of access control for each of MMTEL voice and MMTEL video. Finally, Access Control for Circuit Switched Fall Back (CSFB) is defined.

Extended Access Barring (EAB) is a mechanism for the operator(s) to control mobile originating access attempts from UEs that are configured for EAB in order to prevent overload of the access network and/or the core network. In congestion situations, the operator can restrict access from UEs configured for EAB while permitting access from other “normal” UEs.

A typical use case for the EAB mechanism is a Machine Type Communications (MTC) device. These MTC devices run applications generating data that is typically delay tolerant and thus perceived as low priority traffic by the mobile network. Furthermore, it is expected that the MTC devices are deployed in high numbers, thus making overload situations more common.

Today paging is essentially carried out by transmitting the identifiers of the terminals to be paged over a paging channel. As an example, LTE networks employ two different techniques. In the first technique, a paging channel is divided up into time-based paging occasions and a numeric algorithm based on the identities of the terminals is used to determine which occasion a particular terminal shall be paged at (i.e., the paging group). The terminal needs to monitor the paging only during its paging slot. This limits the amount of listening a terminal needs to do, thus improving battery lifetime. If there is a need to address all UEs listening to a particular paging occasion for some reason, e.g., to inform the UEs about an upcoming system information change, this may be done with a single paging message at the particular paging occasion. In the second technique, if a terminal is to be paged, the system transmits the terminal's S-TMSI (a temporary, unique identifier) or IMSI (International Mobile Subscriber Identity). If multiple terminals are needed to be paged in the same time slot, then their S-TMSI (or IMSI) values are listed (up to the length of the slot, maximum of 16 terminals in LTE Rel-10). Typically, the time slot where the terminals are paged is as in the first case—the paging occasion calculated based on the identifier.

In general, existing paging mechanisms can be divided into the following groups: (1) agreeing on a specific time slot or channel where devices should listen for incoming messages for them; (2) multi-stage mechanisms where the devices are not given a message directly, but only an indication that a message is coming and possibly some further information at which time, on which channel, etc. either the message or some further instructions can be received; (3) designating specific devices to listen for a message at a specific time slot or channel; (4) identifying specific devices in a message by their identifiers; (5) identifying groups of devices in a message by some partial identifier, e.g., the first N bits of an M bit identifier (M>N); (6) identifying groups of devices with some dynamic identifier that has to be agreed between the network and the devices; and (7) using a Bloom filter or some other cryptographic construct to create a space-efficient bit pattern that identifies which nodes need to be woken up. Bloom filters provide information about what nodes are to be woken up. Bloom filter is essentially a compressed set of identifiers, a short bit string. It is easy to test if a specific identifier is or is not in the set. There is a possibility for false positives in this test, but the likelihood can be engineered to be suitable for application in question. In this case it is sufficient to simply make the likelihood of waking up an extra device small enough that the savings from having to send less messages and shorter messages outweigh the costs of an occasional extra device waking up only to realize that it did not receive a message. These paging mechanisms can be used individually or in combination.

In machine-to-machine communication, a network may include an MTC server serving multiple MTC devices. The MTC server may want to control the communication between the device and the server by allowing communication only after the server polls the MTC device. Communication can be based on the IP address of the MTC device, or if this is not possible, the MTC server may trigger the MTC device to establish the connection towards the server. The trigger can be included in a paging message. There are scenarios where many MTC devices must be triggered and addressed at the same time.

Group-based addressing is one of the service requirements for MTC device handling in telecommunication networks. See 3GPP TS 22.368, the contents of which are incorporated herein by reference. MTC Feature Group Based Addressing is intended for use with an MTC group for which the network operator wants to optimize the message volume when many MTC devices need to receive the same message. For the group based addressing MTC feature, the network must provide a mechanism to send a broadcast message within a particular geographic area, e.g., to wake up the MTC devices that are members of that MTC group. Only MTC devices of the target group configured to receive the broadcast message will recognize the broadcast message. The group-based addressing may be used to send information to the MTC devices or to trigger or poll the MTC devices to perform a transmission of data.

In the existing specifications, the defined ACB mechanism does not differentiate between normal priority UEs and low priority UEs, e.g., MTC devices. So far, the EAB mechanism is only described at a high level and needs to be introduced to the specification. This technology described below provides a realization of EAB that is flexible and can be introduced both to the E-UTRAN and UTRAN specifications.

The EAB may be based on a bitmap broadcast in a system information message to identify which access classes 0-9 are barred and which are not; however, this is not mandatory. Changing the barred classes may be done via a system information update message. Several update methods may be employed so that, for example, the alleviation of barring is applied to a large number of UEs belonging to the same AC at the same time, which may cause the large number of now-released UEs to attempt network access at or almost at the same time, which in turn may lead to an overload situation in the RAN. There is a similar problem for group paging. A group page may cause a large number of UEs to simultaneously attempt to access the radio access network (RAN) which can lead into an overload situation in the RAN.

### SUMMARY

A method is provided for controlling access of a user equipment (UE) to a wireless communication network. An access delay is determined for a UE configured for and activated to implement extended access barring (EAB) or included in a group of UEs addressed via group paging. Based on the determined access delay, a timing of an attempt by the UE to access a cell in the wireless communication network is controlled.

The method may be implemented in a network node in the wireless communication network, and in one example embodiment the network node broadcasts in the cell the determined access delay. The determined access delay may be broadcast, for example, using an existing access control barring (ACB) parameter.

The method may be implemented in the UE, and the access delay may be one of a fixed setting in the UE or a fixed parameter received in a broadcast in the cell from the wireless communication network.

In an example embodiment, the timing of the attempt is a random time less than the determined access delay but greater than zero. The UE generates a random number and calculates the timing of the attempt by multiplying the random number by the determined access delay.

In an example embodiment, the UE sets a timer with the determined access delay, and when the timer expires, the UE attempts to access the cell.

For one example implementation, if an EAB bit map for access classes, ACs, 0-9 is broadcast in the cell, then the access delay is a predetermined maximum delay value. If an EAB bit map for access classes, ACs, 0-9 is not broadcast in the cell, then the access delay is zero.

An example embodiment includes calculating a deterministic delay or delay component, and using the calculated deterministic delay or delay component to determine the timing of the attempt. The calculated deterministic delay or delay component is based on the determined access delay and may be calculated as a function of a UE identifier. Still further, the calculated deterministic delay or delay component may be calculated as a function of the UE identifier and an additional factor, A. The additional factor A may for example be one or more of: a secret key used for security in the UE, a per UE property, a commonly-known addition factor, a per UE class property, a system frame number, or a connection frame number. The additional factor A may also be used to create access attempt fairness for multiple UEs attempting to access the cell.

The determined access delay is a time period over which access attempts to the wireless communications network from multiple UEs are spread out. The determined access delay is determined based on a parameter T in some example embodiments. T may be decided in a variety of ways. One non-limiting example is to determine the parameter T based on a load in the cell or in the wireless communication network.

At least multiple ones of the UEs are EAB-configured UEs, and the EAB-configured UEs are barred from attempting access to the wireless communications network based on a first value of the parameter T and are not barred from attempting access to the wireless communications network based on a second different value of the parameter T. Example values include the first value of zero and the second value of infinity. Both the parameter T and an EAB flag may be sent or received. The EAB flag indicates whether EAB is on or off.

Another non-limiting embodiment where the determined access delay is also determined based on a parameter T initiates a barring timer for the UE. If a value of the parameter T changes to a value less than a time remaining of the bar timer, then the UE calculates a new delay for shortening the time for the UE to attempt to access the cell in the wireless communication network.

If the UE roams outside of its home wireless communication network, the UE calculates a roaming timer value based on the parameter T and a roaming factor.

In another non-limiting embodiment, the determined access delay is a different value for different access classes, for different UEs, of for different operators.

The determined access time may be compared to a threshold, and if the determined access time exceeds the threshold, an indication may be sent that the UE is barred access to the cell. If the determined access time is less than or equal to the threshold, an indication may be sent that the UE is not barred access to the cell.

### BRIEF DESCRIPTION OF THE DRAWINGS

The foregoing and other objects, features, and advantages will be apparent from the following more description of example embodiments as illustrated in the accompanying drawings in which reference characters refer to the same parts throughout the various views. The drawings are not necessarily to scale, emphasis instead being placed upon illustrating principles.

FIG. 1 illustrates an example communication network for communication by MTC devices;

FIG. 2 illustrates the concept of congestion over the radio interface when a large number of UEs, like MTCs, attempt to access the RAN via a base station at the same time;

FIG. 3 is a schematic view of example apparatus for an example communications network that illustrates example method steps for introducing a spreading time period T into access control aspects of the network and UEs in communication with the network;

FIG. 4 is a flowchart diagram illustrating example procedures implemented by a network node in accordance with an example embodiment;

FIG. 5 is a flowchart diagram illustrating example procedures implemented by a UE in accordance with another example embodiment; and

FIGS. 6A-6C illustrate signaling diagrams for non-limiting, example embodiments.

### DETAILED DESCRIPTION

In the following description, for purposes of explanation and not limitation, specific details are set forth such as particular architectures, interfaces, techniques, etc. However, it will be apparent to those skilled in the art that the technology described may be practiced in other embodiments that depart from these specific details. That is, those skilled in the art will be able to devise various arrangements which, although not explicitly described or shown herein, embody the principles described and are included within the spirit and scope of the appended claims. In some instances, detailed descriptions of well-known devices, circuits, and methods are omitted so as not to obscure the description with unnecessary detail. All statements herein reciting principles, aspects, and embodiments, as well as specific examples thereof, are intended to encompass both structural and functional equivalents. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be implemented by computer program instructions that may be stored in a non-transitory, computer-readable storage medium and which when executed by a computer or processor cause the processes to be performed, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

For illustrative purposes, the description sets forth example embodiments in the context of a network operating according to the Long-Term Evolution (LTE) standard. Those skilled in the art will appreciate, however, that the technology described is applicable to other wireless communication systems, including for example GSM/EDGE (Global System for Mobile Communication (GSM) Packet Radio Service), Wideband Code Division Multiple Access (WCDMA), Worldwide Interoperability for Microwave Access (WiMAX) systems, etc.

The terms User Equipment (UE) and access terminal are used herein to refer generally to an end terminal that attaches to a wireless communication network, and include MTC devices, non-MTC devices, and any other wireless devices, such as but not limited to cell phones, wireless-equipped personal digital assistants, wireless cards or modules that are designed for attachment to or insertion into another electronic device, such as a personal computer, electrical meter, etc.

Likewise, unless the context clearly indicates otherwise, the term base station is used in its most general sense to refer to a wireless access point in a wireless communication network, and may refer to base stations that are controlled by a physically distinct radio network controller as well as to more autonomous access points such as the so-called evolved Node Bs (eNBs) in Long-Term Evolution (LTE) networks. A network node includes base stations and other network nodes.

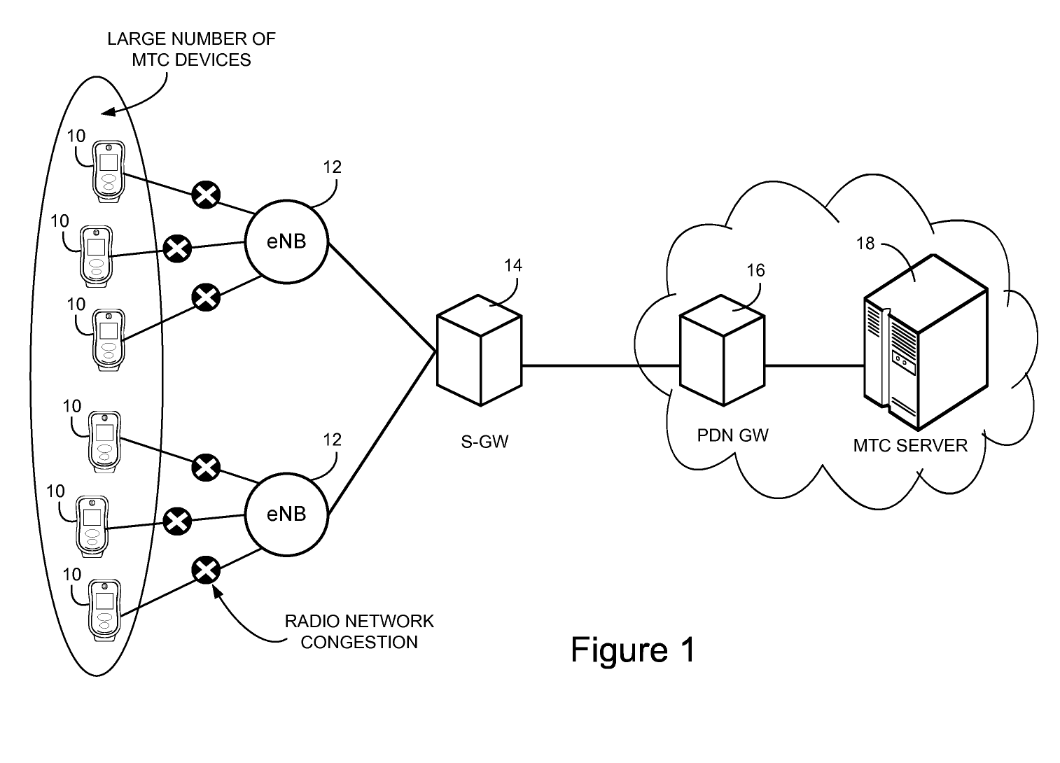

FIG. 1 illustrates one example of a communication network including a core network node such as a serving gateway (S-GW) 14, a plurality of base stations 12 referred to in LTE as eNBs, and a large number of communication devices 10 including many MTC devices. Access to the wireless communication network may, for example, be by way of a contention-based random access channel (RACH). Multiple base stations 12 provide network access to the UEs 10, and in LTE, collectively form a radio access network (RAN). The S-GW 14 connects to an external packet data network (PDN) such as the Internet via a PDN Gateway (PDN GW) 16. The UEs 10 may communicate with one or more servers, including one or more MTC servers 18, connected to the S-GW 14 or to the PDN GW 16 as shown.

The UEs 10 include MTC devices for collecting and reporting of data over a communication network and/or non-MTC devices. Machine Type Communications (MTC) has been defined as a specific type of wireless communication network traffic. See, e.g., 3GPP Technical Report 23.888, “System Improvements for Machine-Type Communications,” the disclosure of which is incorporated herein by reference in its entirety. One example of an MTC device is a gas or power meter with a wireless transceiver for reporting at predetermined time periods, or event-based, the usage of gas or electrical power to the MTC server 18. Non-MTC devices are devices, such as a cell phone, smart phone, laptop computer, etc., used for voice and data communications by human users. An MTC device may comprise a dedicated device specifically for data collection and reporting. In other embodiments, a combined UE 10 may function part of the time as an MTC device and part of the time as a non-MTC device.

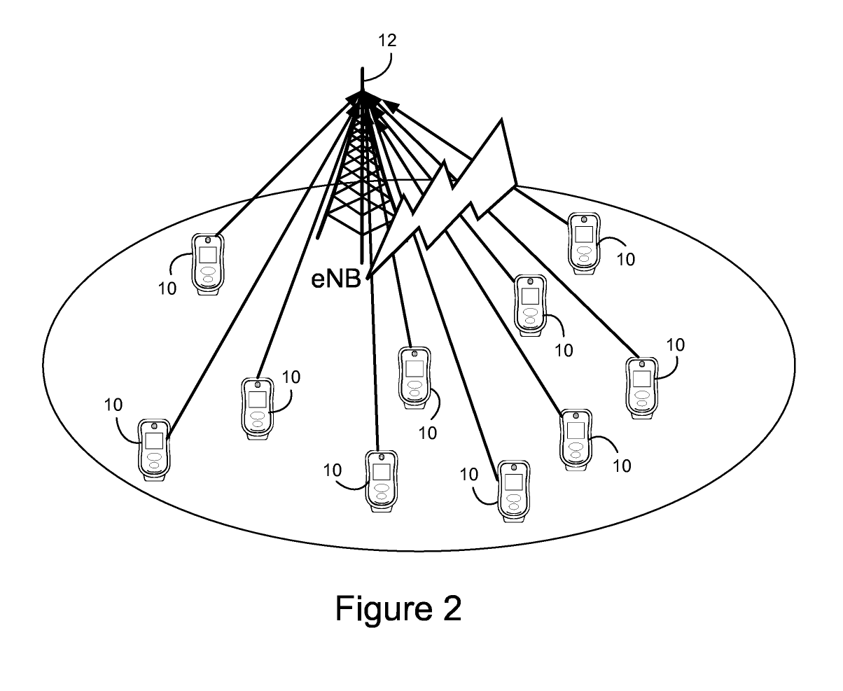

Both MTC devices and non-MTC devices all must contend with one another for access on the RACH. Due to the rapid growth of MTC devices, it is expected that the number of MTC devices will far exceed the number of non-MTC devices in the near future. Those large numbers will likely result in congestion, for example in the radio network, particularly when many of the MTC devices simultaneously try to access the network. The congestion is shown a white X in a black circle in FIG. 1 and as a lightning bolt in FIG. 2. The term “simultaneous” is not limited to exactly the same time but also includes a same time period during which multiple UEs are all trying to access the same radio resources that potentially can result in conflict and/or congestion.

The technology disclosed herein regulates such access attempts so that conflicts and/or congestion can be avoided or at least reduced. Methods and apparatus are provided that may be used for example in the WCDMA/UTRAN and/or LTE/E-UTRAN specifications for Extended Access Barring (EAB) configured UEs or for UEs in a group of users addressed via group paging. An access attempt delay parameter T is introduced over which network access attempts from EAB-enabled UEs are spread. The access attempt delay parameter T may be broadcast to all UEs in a system information message. Alternatively, the UE may be provided the access attempt delay parameter T as a fixed setting or as a per UE setting, e.g., manually, via direct signaling, or other.

In one example embodiment, a UE configured for Extended Access Barring or included in a group of users addressed via group paging determines an access attempt delay based on the value of parameter T which the UE then uses to determine when to attempt access to a wireless communication network. In other words, that UE uses that parameter T to control timing of an access attempt to the network. In another example embodiment, a base station may control timing of access attempts of a UE configured for Extended Access Barring or included in a group of users addressed via group paging by configuring that UE to determine an access delay for when to attempt access to the network based on T. For ease of description, an Extended Access Barring UE is referred to below, but the description equally applies to a UE included in a group of users addressed via group paging.

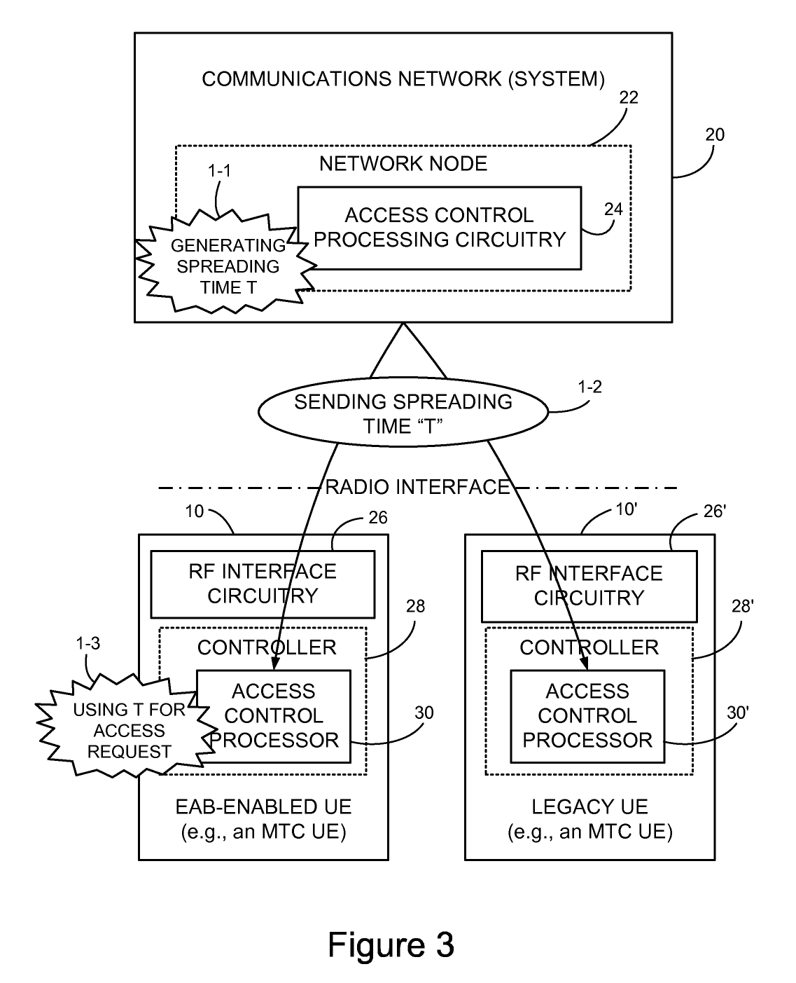

FIG. 3 is a schematic view of example apparatus for an example communications network that illustrates example method steps for introducing an access attempt delay parameter T into access control aspects of the network and UEs in communication with the network. The broken lines in FIG. 3 in both the communications network/system structure and the UE structure depict example platforms which may host the respective access control functionalities or units. The term “platform” describes how functional units or entities framed thereby may be implemented or realized by a machine including electronic circuitry. One example platform is a computer implementation where one or more of the framed elements are realized by one or more processors which execute coded instructions in order to perform the various acts described herein. In such a computer implementation the UE may comprise, in addition to a processor(s), a memory section, which in turn may comprise a random access memory; a read only memory; an application memory; and any other memory such as cache memory, for example. The memory section, e.g., the application memory, may store, e.g., coded instructions which can be executed by the processor to perform acts described herein. The UE platform may also comprise other input/output units or functionalities, such as a keypad; an audio input device, e.g., microphone; a visual input device, e.g., camera; a visual output device; and an audio output device, e.g., a speaker. Other types of input/output devices can also be connected to or comprise the UE. Another example platform suitable for the UE is a hardware circuit, e.g., an application specific integrated circuit (ASIC) where circuit elements are structured and operated to perform the various acts described.

FIG. 3 includes a communications network or system 20 in communication over an air or radio interface with one or more UEs, including an example nominal or legacy UE 10′ and a EAB-enabled UE 10. As explained above, the EAB-enabled UE may also be a UE addressed via group paging and reference to an EAB-enabled UE includes a UE addressed via group paging. The block 20 shown in FIG. 3 as the network or system may comprise a core network and a radio access network (RAN). The radio access network (RAN) includes one or more levels of network nodes, such as radio network controller nodes and base station nodes in the UTRAN radio access network and an eNodeB or the like in an LTE radio access network.

The communications network/system includes access control processing circuitry 24 which introduces the access attempt delay parameter T into information that is broadcast to UEs. The access control processing circuitry 24 may be included in or comprise either a core network node or a radio access network node, e.g., a radio network controller node, a base station node, or a eNodeB, for example. The reference numeral 22 therefore refers to a network node that includes any of the above or similar. The access attempt delay parameter T may be broadcast to the UEs in system information shown at 1-2 such as a SIB message. The access control processing circuitry 24 may include radio resource control (RRC) functionality which may be involved in the generation and/or introduction of the access attempt delay parameter T. FIG. 3 further shows the access attempt delay parameter T being received through an RF interface of plural UEs 10, 10′ and used by access control processors 30, 30′ of the respective UEs 10, 10′. The legacy UE and the EAB-enabled UE may utilize the access attempt delay parameter T differently, as explained herein. The access control processors 30, 30′ of the respective UEs may not only be configured to receive the parameter T from the network/system, but also to utilize the access attempt delay parameter T in conjunction with access requests to determine whether access by the particular UE is barred or whether the UE can access the network, as described, e.g., in the embodiments mentioned herein or otherwise encompassed hereby. In the embodiments described below, it will be understood that the access control processors of the UEs are configured to perform the respective operations, acts, or steps described with respect to the corresponding example embodiment.

In terms of non-limiting, example acts or steps of a general method, FIG. 3 shows by reference 1-1 an act of the network/system generating or determining an access attempt delay parameter T. Act 1-2 indicates the network/system sending the access attempt delay parameter T to the UEs. FIG. 3 further depicts by reference 1-3 an act of an example UE 10, such as a EAB-enabled UE, utilizing the access attempt delay parameter T in conjunction with an access request attempt to determine whether access by the particular UE is barred or whether the UE can access the network.

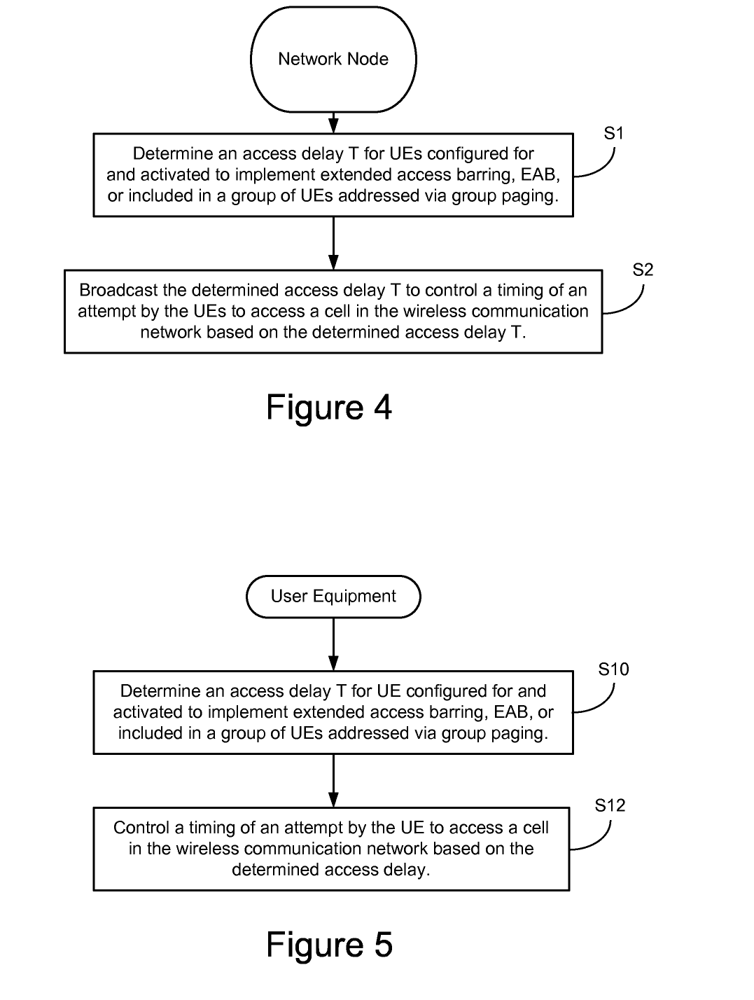

FIG. 4 is a flowchart diagram illustrating example procedures implemented by a network node in one example embodiment consistent with the example shown in FIG. 3. The network node initially determines an access attempt delay parameter T for UEs configured for and activated to implement extended access barring (EAB) or included in a group of UEs addressed via group paging (step S1). The node then broadcasts the determined access attempt delay parameter T to control a timing of an attempt by the UEs to access a cell in the wireless communication system based on the access attempt delay parameter T (step S2).

FIG. 5 is a flowchart diagram illustrating example procedures implemented by a UE in accordance with another example embodiment. The UE initially determines, e.g., using its access control processor 30, an access attempt delay parameter T for the UE, which is configured for and activated to implement extended access barring (EAB) or included in a group of UEs addressed via group paging (step S10). The UE then controls a timing of an attempt by the UE to access a cell in the wireless communication system based on the access attempt delay parameter T (step S12).

As one non-limiting example implementation, an existing ACB parameter “ac-barringTime” described in the 3GPP specifications identified above and used in legacy systems may be used to carry the access attempt delay parameter T. (Similar ACB parameters may also be used to carry the access attempt delay parameter T for this example embodiment.) The ac-barringTime parameter is typically sent in a System Information Block Type 2 (SIB Type 2) message when Access Class Barring is in use in the cell. When a normal UE attempts network access, the normal UE receiving a SIB Type 2 message ignores this ac-barringTime parameter or uses it as in a legacy ACB system. But before an EAB-configured UE attempts network access, that EAB-configured UE reads the value of the ac-barringTime parameter, including the access attempt delay parameter T value, received in a SIB Type 2 message or the like and uses the access attempt delay parameter T included in the ac-barringTime parameter as indicated for EAB operations. The UE may also use the ac-barringTime parameter for legacy Access Class Barring (ACB) operations, if and when applicable.

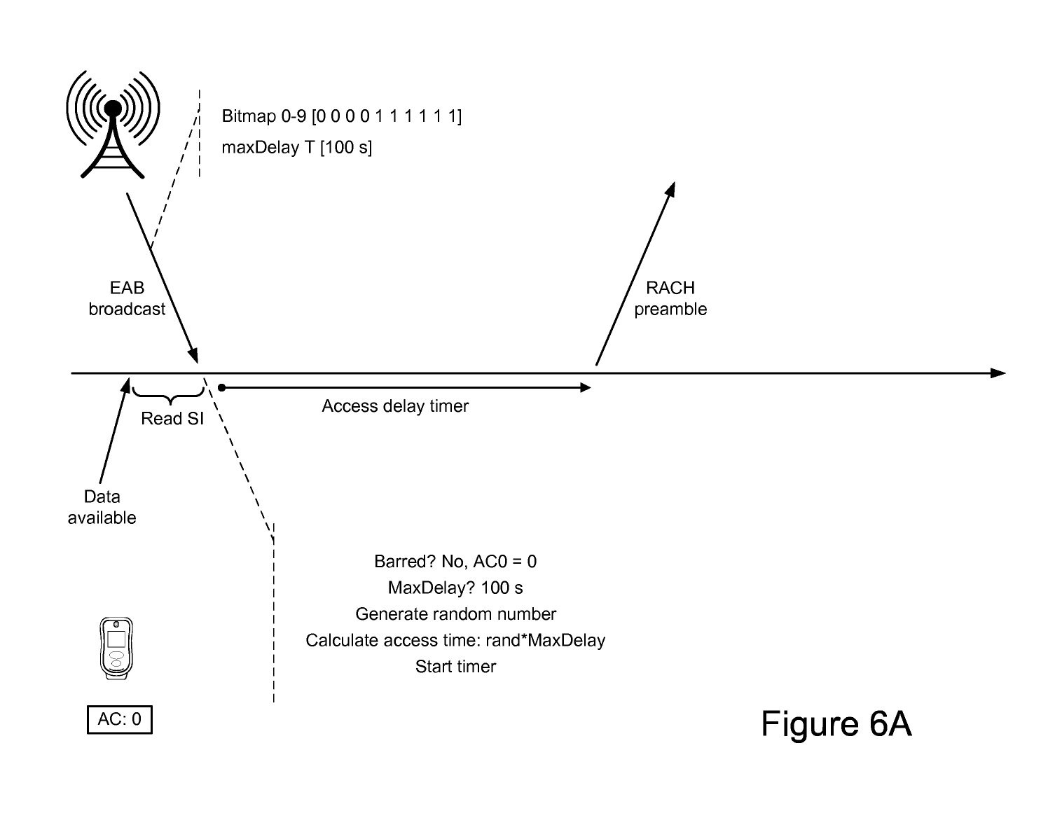

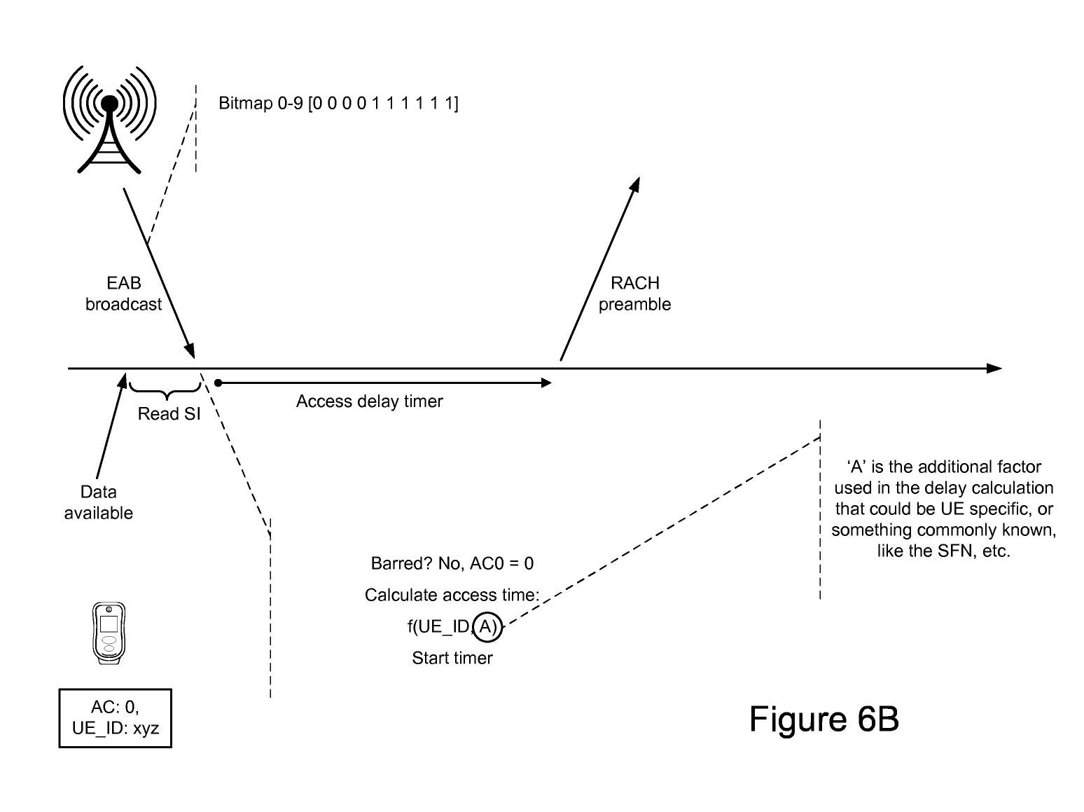

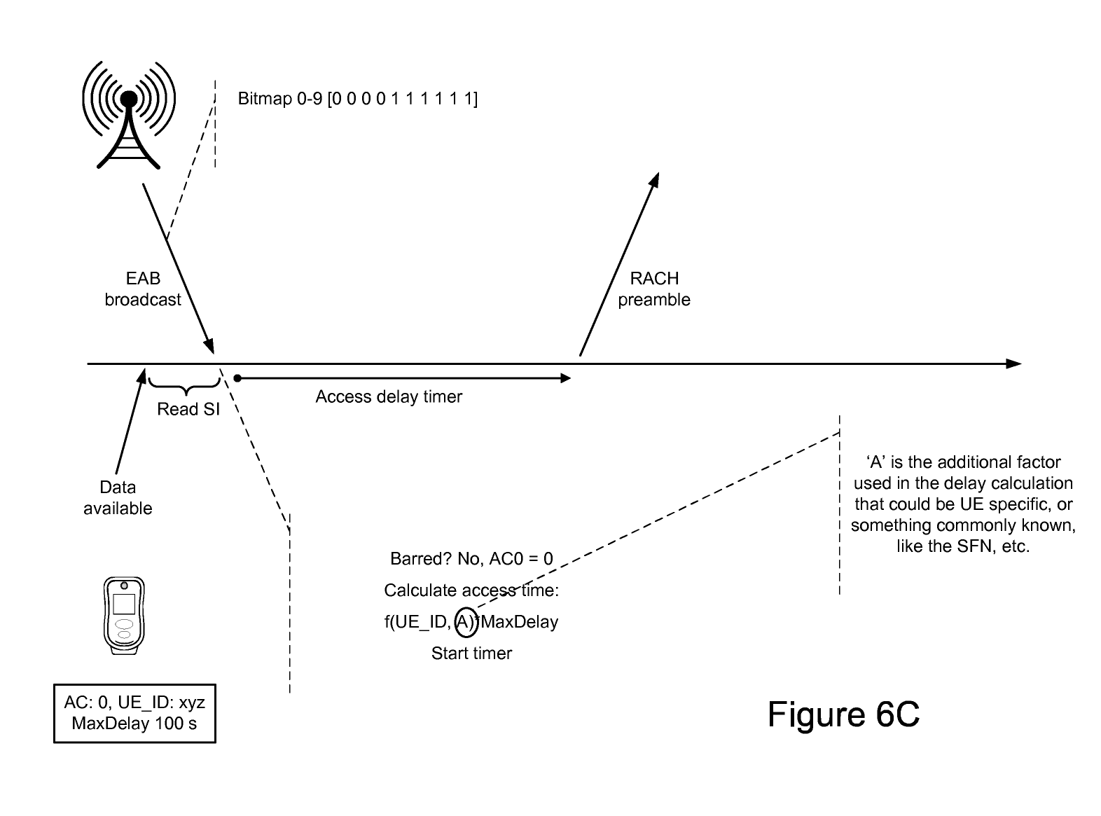

Non-zero values of the access attempt delay parameter T delay access attempts of EAB-configured UEs, thereby limiting access from these UEs. An EAB-configured UE may select a random access time that is distributed within the boundaries from 0 to T, e.g., the random access times may be uniformly distributed over the time period T. In one example embodiment, the UE selects a random access time uniformly distributed within the boundaries from 0 to T. An example of this embodiment is illustrated in the signaling illustration of FIG. 6A where an EAB bitmap is broadcast together with an access attempt delay parameter T, which in this non-limiting example is 100 seconds. The parameter T in these figures is referred to s MaxDelay. The UE, which belongs to access class AC 0, reads the system information (SI) in the broadcast to determine whether the UE is barred and the access attempt delay parameter T. In this case, the barring bitmap 0-9 [0000111111] indicates that the bit for AC 0 (the first bit from the left) is set to 0, which means that the UE is not barred. Thereafter, the UE generates a random number, which may be a number between 0 and 1, and calculates the access time by multiplying the generated random number with T as shown: rand*MaxDelay. The UE sets a timer with the calculated access time value, and when the timer times out, the UE makes its access by sending a RACH preamble. Of course, making network access, e.g., sending a RACH preamble, does not guarantee network access. There may be a collision on the RACH with one or more other UEs, too much congestion, etc., in which case the UE must retransmit its access attempt, likely in accordance with some already established retry protocol.

The access attempt delay parameter T value may be configured in/to the UE SIM or corresponding UE structure, e.g., by an operator. The value may be dependent if the UE is in its home public land mobile network (PLMN), or it is a roaming UE. Furthermore, T may be set to a different value per access class or even per UE, if so desired by the operator. The value of T may also be derived based on some other information. For example, if an EAB bitmap for AC 0-9 is broadcast, then, by pre-agreement, the value of T may be understood as T_max, and if the EAB bitmap for AC 0-9 is not broadcast, then the value of T may be understood to be 0.

The parameter T broadcast in system information may be defined in a Radio Resource Control (RRC) specification. The number of possible T values depends on the number of bits used to convey this information. The network may dynamically change the value of the parameter T. T may range from a limited set of values. In case of using 2 bits, T may be defined with 4 values. If 3 bits are used, T may have 8 different values. In case the legacy parameter ac-accessBarring in E-UTRAN is reused for this purpose, the existing value set may be used, or a new set of values may be defined for EAB configured UEs. For example, the value zero could be the minimum value, while “infinity” (or “inf”) could be the maximum value.

Alternatively, instead of using a random access time within 0-T, a similar (e.g., uniform) distribution of UE accesses may be achieved in a deterministic manner by calculating a deterministic delay or delay component “det-t.” Information already available in the UE may be used to calculate the deterministic delay or delay component det-t. Examples of this deterministic delay or delay component det-t embodiment are now described.

A deterministic delay or delay component det-t may be calculated with the parameter T, which may be provided by the network to the UE or determined by the UE. The parameter T may also be included as a fixed value in standard or be set as a maximum value from a deterministic delay algorithm. In some cases, the delay det-t indicating the access time may be calculated without the use of T. In those cases, a system information (SI) broadcast of T is omitted. Also, an algorithm used to determine the deterministic delay may provide better security. This may be a hash function, for example, so that only the UE knows its delay so as to prevent a “man in the middle” attack where an attacker knowing the UE's access delay might pose as the UE to the network.

A function f may be used to calculate the deterministic delay or delay component det-t. Although the function f may be calculated in several ways, one example is now explained. The input for the function includes a UE identity, UE-id, and optionally one or more additional parameters A. Consider the function:

det-t=f(UE-id,A)

The function f may be a simple subtraction and/or addition, or it may be a hash function such as an MD5 (Message Digest algorithm 5) operation, SHA1 (Secure Hash Algorithm 1) operation, or a shift/XOR type of operation. Again, a hash function may be used to protect the UE delay calculation from outside attack.

FIG. 6B illustrates a signaling example for this particular non-limiting embodiment. The base station broadcasts an EAB bitmap in system information (SI), and the UE, which is in access class AC 0, reads the SI to determine whether it is barred (in this case the UE is not barred). Thereafter, the UE calculates a delay for determining the access time using the function f with a UE id, (indicated in the figure as xyz), and an additional parameter A as input. As indicated in the figure, A may be UE-specific, something commonly known like a system frame number (SFN), etc. The UE calculates the access time using the function f(UE-id, A) as shown. The UE sets a timer with the calculated access time value, and when the timer times out, the UE makes its access by sending a RACH preamble. Of course, making network access, e.g., sending a RACH preamble, does not guarantee network access. There may be a collision on the RACH with one or more other UEs, too much congestion, etc., in which case the UE must retransmit its access attempt, likely in accordance with some already established retry protocol.

Another alternative example approach is to calculate a delay component det-t with a function f, and then scale this delay component det-t value with delay parameter T. If the output of function f varies between 0 and 1, then the total delay varies for example between 0 and T. This non-limiting example embodiment is illustrated in FIG. 6C with the output of example function f(UE-id, A) multiplied with the delay parameter T having an example value of 100 seconds. In this example, the delay parameter T is not broadcast because it is known to the UE, e.g., it may be a standardized fixed value or configured on the user equipment SIM or USIM by the operator.

A fixed offset may also be added to the delay: det-t=offset+f(UE-id, A)*T.

The UE identity (UE-id) is an identifier that is typically present in the UE. Example UE identities include IMEI, IMSI, TMSI, etc. The access class of the UE may also be used (although this access class is shared between several UEs). The parameter UE-id may be an actual UE identity or it may be derived from the actual UE identity, e.g., by truncating some of the significant bits or less significant bits or by performing a modulo operation.

The additional factor A may be used to create fairness between UEs. This is useful because if the access delay is determined by the UE identity, some UEs may always experience longer delays than others.

Four other example additional factor A embodiments are now described. The first is a secret additional factor where the secret key used for security in the UE (or a key derived from it) is used as the additional factor A. Using the secret security key as the additional factor A is advantageous in that the actual access moment used by the UE is only known by the UE, thereby reducing the risk of potential security threats. A second is a per UE additional factor, examples of which include:

1—a per UE factor communicated to the UE via paging; measurement information such as Reference Signal Received Power (RSRP), Received Signal Strength Indicator (RSSI), or Channel Quality Indicator (CQI) index, etc.;

2—location information such as location coordinates, ellipsoid point, or other commonly known location parameter value;

3—a random access preamble value that the UE may choose to be used in the upcoming access attempt;

4—a per UE factor configured to the UE SIM, or corresponding entity, by the operator that may change if the UE is accessing its own Home PLMN or some other PLMN;

5—a UE factor that can be time-variable and depend on some event. For example, the UE factor can depend on number of access attempts the UE has done. It can be that for the first access attempt the UE factor can be 1, 2 for the second attempt, and so on; and

6—a UE factor that depends on a Cell Radio Network Temporary Identifier (C-RNTI) of a previous connection.

Using per UE measurement, location, or preamble information as the additional factor A also has advantages from a security perspective.

A third additional factor “A” embodiment uses a commonly known additional factor. Preferably, some time changing value from the system information broadcast, such as the system frame number (SFN), is used as the additional factor. Another example is a Connection Frame Number (CFN). A fourth additional factor “A” embodiment is a per UE class additional factor that depends on UE class. One example is to calculate the additional factor based on the UE access class number.

Numbered non-limiting, example embodiments are now described, and are numbered simply for ease of reference. For each example embodiment, either a random number generated in the UE or the function f may be used for calculating the access time in the form of a delay or delay element det-t.

Example embodiment 1 includes the option of barring UEs from any access to a cell for a period of time T. Among the values for T, at least one of the values indicates to an EAB-configured UE that the cell is barred, i.e., a positive, non-zero value, and one of the values indicates that the cell is not barred, i.e., T=0. A non-zero T value indicates that the cell is barred and also conveys timing information. The UE uses the T value to deterministically or randomly select a time to indicate to higher layers when the barring to that cell is lifted or removed and/or to indicate when the UE can access the network, i.e., when the time T is over.

In an example, non-limiting implementation of embodiment 1, if T=0, the cell is not barred and the UE may attempt to access the network without delay. If 0<T<inf, the UE's attempted network access will be delayed. The UE may now determine a uniform random number “rand” between 0 and 1, and multiply “rand” with T. The resulting value is the “access delay” applied to this UE. The UE starts a barring timer with the access delay value and informs higher protocol layers in the UE's protocol stack that the access attempt to the cell is barred. When the barring timer expires, higher protocol layers are informed that barring is lifted. When the barring timer expires, the higher protocol layers may trigger a new access attempt for the UE. If T=infinity, then the cell is barred, and the UE may inform higher protocol layers that no access is allowed. If the system information changes so that T<infinity, then the UE may inform the higher protocol layers that the barring is lifted.

Embodiment 2 delays a network access attempt. Among the values for T, at least one value indicates to the UE that the cell is barred, and at least one value indicates that the cell is not barred. The values which indicate that the cell is not barred also convey timing information. The UE uses the value to deterministically or randomly select a delay after which the UE may access the network. A difference from embodiment 1 is in what happens when barring is lifted. In example embodiment 1, the UE does not attempt network access when the timer T expires, but instead only informs a higher protocol layer that a new network access attempt may now be made. But here in example embodiment 2, the UE proceeds directly to attempt network access on the lower protocol layer. In this particular case, the lower layer is the RRC layer and the higher layer is the non-access stratum (NAS) layer. Another example if the RRC layer is the higher layer, the Packet Data Convergence Protocol (PDCP)/Radio Link Control (RLC)/Medium Access Control (MAC) layer may be the lower layer.

In an example, non-limiting implementation of embodiment 2, if T=0, then the cell is not barred, and the UE may attempt to access the network without delay. If 0<T<inf, then attempted network access is not barred but delayed. The UE now determines a uniform random number “rand” and multiplies “rand” with T. Then the UE starts an access delay timer, and upon expiry of the counter, the UE may attempt to access the network. If T=infinity, then the cell is barred, and the UE informs higher protocol layers that no attempted access to this cell is allowed until further notice. Whenever the system information changes so that T<inf, the UE informs higher layers that the barring is lifted.

In embodiment 3, an EAB flag together with the parameter T is broadcasted by a base station. The EAB flag is a one bit parameter indicating whether EAB is on or off. If the flag indicates that the EAB functionality is on, then barring applies, and the same procedures as described in embodiments 1 or 2 may be used to determine the barring status and access attempt delay. However, when the EAB functionality is turned off, all EAB-configured UEs may attempt to access to the network without delay. With embodiment 3, there is no need to send a T=0 value or any T value for that matter.

In embodiment 4, an EAB flag together with the parameter T is broadcasted as in the previous embodiment. But here the EAB flag is a one bit parameter indicating whether the UE is barred or not. If the flag indicates that the EAB UE is not barred, then access attempt delaying applies, and the same procedures as described in embodiments 1 and/or 2 may be used to determine the UE's access attempt delay. But when EAB is barred, all EAB-configured UEs are barred with no access attempts permitted to the network, which is the same result as when T=infinity. But in this case, there is no need to send the value T=infinity.

In embodiment 5, an EAB flag together with the parameter T is broadcasted, just as in previous embodiments, but this time the EAB flag is a one bit parameter indicating whether the UE is barred or not. If the flag indicates that the UE is not barred, then the UE attempts a network access with a delayed time as explained in embodiment 2. If the EAB indicates that the cell is barred, then all EAB-configured UEs are barred using for a period of time as explained for embodiment 1. In embodiment 4, the access delay is calculated when the UE is not barred. If barred, the the UE needs to wait until the barring status changes. In this embodiment 5, the access delay is calculated in both situations, but depending on flag status it causes either barring or access delay.

Embodiment 6. If during the EAB procedure, a cell is considered as not barred, the UE does not access the network immediately or after a delayed time, but rather applies an already-defined ACB mechanism. For example, if EAB indicates that a cell is not barred and a UE can attempt network access without delay, then the UE starts an ACB mechanism such as is described in current 3GPP specifications. If EAB indicates that the cell is not barred and the UE can make an access attempt after an access delay time period, then the UE starts a normal ACB mechanism, e.g., as specified in 3GPP TS 36.321 or 3GPP TS 25.331, after that access delay time.

Embodiment 7 is an enhancement of embodiment 1 and addresses a problem of potentially long access delays that may result in embodiment 1. A local Boolean type flag “barred” set with an initial value TRUE is added in to the UE to help tackle the problem of long access delays. Note that this local flag in the UE memory is not broadcast as it is in Embodiment 5. Following embodiment 1, whenever “barred” indicates TRUE, the procedures in embodiment 1 are followed. Whenever the barring timer expires, the local Boolean type flag “barred” is set to FALSE. Whenever access to the cell is allowed, the local Boolean type flag “barred” is again set to TRUE. Thus, each new access attempt starts with the UE being barred.

Embodiment 8 is a variation of embodiment 5, where the flag barred is set to TRUE. In addition, whenever system information indicates a longer T value than the previous T value, the UE used for its previous access delay calculation.

Embodiment 9 may be used along with any of embodiments 1-8. An access delay timer (like that in FIGS. 6A-6C) to indicate higher layers about barring alleviation is started. The UE may monitor the system information during the barring, and if the value of T changes to a value less than the time remaining on the timer, then the UE may calculate a new barring delay to shorten its waiting time for access. The UE may select the shortest value of the newly-generated access delay and the remaining time of the already-running delay timer. Thus, if the overload situation eases up and the network changes the EAB broadcast values to allow for faster access, then UEs previously barred may attempt to access the network faster.

Embodiment 10 may be used along with any of embodiments 1-8. A delay timer to delay access is started. The UE monitors system information during the delay, and if the value of T changes to a value less than the time remaining on the delay timer, then the UE calculates a new access delay to shorten its waiting time for attempting network access.

In embodiment 11, EAB-configured UEs that are not located in their home PLMN (HPLMN), multiply the access delay parameter T with a multiplier, e.g., “T_multiplier,” which may also be broadcast from the cell. UEs not in their HPLMN maintain a timer T_roaming=T*T_multiplier. In the absence of T, or if T is equal to 0, the absolute value T_roaming is broadcast at the network. If T=0, then 0*Tmultiplier should be 0 too, which is why T_roaming must be broadcast in this situation to permit an operator's own UEs to have a zero delay but roaming UEs to have a non-zero delay. In other words, some operators may want to delay accesses from roaming UEs with a longer time than their own UEs.

For embodiment 12, the value of T is broadcast per operator when multiple operators share a radio access network. In other words, a set of T values, one per operator, is broadcasted in the cell.

Embodiment 13: a multiplier T_operator is broadcast in the system, and each UE within an operator's network applies T=T*T_operator. Here, the system broadcasts one T and one multiplier per operator in order to realize different types of barring for different operators. If operator A does not need barring, then operator A may set T_operatorA to 0, and thus T*T_operatorA=0. Operator B needs barring, and thus, sets T_operatorB to a non-zero value to enable barring for UEs registered in operator B's network.

Embodiment 14: the value of T in embodiments 1-12 is set based on a load L in the network.

Embodiment 15: the load L is estimated based on one or more of: i) Physical Resource Block (PRB) utilization in the cell, ii) a number of EAB-configured UEs in the cell (MTC devices), iii) RACH load in the cell, i.e., number of RACH attempts, or collisions within a given time window, iv) number of known EAB-configured UEs (such as MTC devices) located at fixed positions within the cell, and/or v) uplink interference level in the cell.

Embodiment 16: The value of T in embodiments 1-14 is based on a consideration of the load K in a nearest N neighbor cells, where the load estimation L per neighbor cell is based on one or more of the parameters listed in embodiment 15.

Embodiment 17: The network or system where any of the embodiments 1-16 is implemented is an E-UTRAN network or system. For any parameter(s) used to set the value of T that is/are not available at the base station, like uplink interference level or number of RACH attempts in the neighboring cell, those parameter(s) are transmitted via a communicating interface between base stations, i.e., over the X2 or S1 interface.

Embodiment 18 is a combination of embodiments 1-8. The UE first determines an “access delay” parameter value X based on a broadcast value of T and a random number rand. If the determined “access delay” parameter X value exceeds a threshold TH, then the UE indicates to a higher protocol layer in the UE's protocol stack that access to the cell is barred. When the timer based on value X expires, the UE indicates to the higher protocol layer that barring is over. Then the higher protocol layer may trigger a new access attempt. Alternatively, if the determined “access delay” parameter X value exceeds the threshold TH, then the UE provides to a higher protocol layer the value of the “access delay” parameter X value. Based on the access delay parameter X value, a higher protocol layer in the UE triggers a new access attempt to the cell. However, if the “access delay” parameter X value is less than or equal to the threshold TH, then the UE does not indicate that it is barred to a higher protocol layer. In this situation, the RRC layer (or corresponding protocol layer) itself triggers a new access attempt. The value of the threshold TH may be broadcast by the network or it may be configured to the UEs with higher protocol layers, e.g., an RRC or NAS layer, using dedicated signaling or specified values.

Embodiment 19: The access class (AC) of the UE may also be used for barring as is done currently in UTRAN and may be done in a similar way in LTE. In this case, the network informs via broadcast which ACs are barred and which are not. In UTRAN, the current broadcast information is a bitmap identifying which class is barred and which is not. This barring information can be used as the EAB flag in embodiments 3-17.

The technology disclosed has many advantages. Example, non-limiting advantages include spreading the access attempts from EAB-enabled UEs over a period of time decided by the network, thus lessening congestion and risk for a new overload situation. With the dynamic setting of the delay on the basis of load in the cell and within its closest neighbors, the system has flexibility in reacting into load changes. Spreading accesses when alleviating EAB barring is important since the barring function will cause UEs to queue for the next possible transmission, i.e., the transmission that occurs right after barring is lifted. If accesses are not spread when barring is lifted, the network may end up in a worse overload situation than that for which the barring was originally turned on. In a worst case, the resulting extreme sudden overload may lead to network failure.

Although the description above contains many specifics, these should not be construed as limiting the scope of the claims but as merely providing illustrations of example embodiments. It will be appreciated that the technology claimed fully encompasses other embodiments which may become obvious to those skilled in the art, and that the scope of the claims is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved for it to be encompassed hereby.

1. A method for controlling, access of a user equipment, UE, to a wireless communication network, comprising the steps of:
determining an access delay for a UE configured for and activated to implement extended access barring, EAB, or included in a group of UEs addressed via group paging, and
controlling a timing of an attempt by the UE to access a cell in the wireless communication network based on the determined access delay.

2. The method in claim 1, implemented in a network node in the wireless communication network, the method further comprising broadcasting in the cell the determined access delay.

3. The method in claim 2, wherein the determined access delay is broadcast using an existing access control barring, ACB, parameter.

4. The method in claim 1, implemented in the UE wherein the access delay is one of a fixed setting in the UE or a fixed parameter received in a broadcast in the cell from the wireless communication network.

5. The method in claim 1, wherein the timing of the attempt is a random time less than the determined access delay but greater than zero.

6. The method in claim 5, wherein the UE generates a random number and calculates the timing of the attempt by multiplying the random number by the determined access delay.

7. The method in claim 1, further comprising controlling the UE to set a timer with the determined access delay, and when the timer expires, the UE attempts to access the cell.

8. The method in claim 1, wherein if an EAB bit map for access classes, ACs, 0-9 is broadcast in the cell, then the access delay is a predetermined maximum delay value, and if an EAB bit map for access classes, ACs, 0-9 is not broadcast in the cell, then the access delay is zero.

9. The method in claim 1, further comprising:
calculating a deterministic delay or delay component, and
using the calculated deterministic delay or delay component to determine the timing of the attempt.

10. The method in claim 9, wherein the calculated deterministic delay or delay component is based on the determined access delay.

11. The method in claim 10, wherein the calculated deterministic delay or delay component is calculated as a function of a UE identifier.

12. The method in claim 11, wherein the calculated deterministic delay or delay component is calculated as a function of the UE identifier and an additional factor, A.

13. The method in claim 12, wherein the additional factor A is one or more of: a secret key used for security in the UE, a per UE property, a commonly-known addition factor, a per UE class property, a system frame number, or a connection frame number.

14. The method in claim 12, further comprising using the additional factor A to create access attempt fairness for multiple UEs attempting to access the cell.

15. The method in claim 1, wherein the determined access delay is a time period over which access attempts to the wireless communications network from multiple UEs are spread out.

16. The method in claim 1, wherein the determined access delay is determined based on a parameter T, wherein at least multiple ones of the UEs are EAB-configured UEs, and wherein the EAB-configured UEs are barred from attempting access to the wireless communications network based on a first value of the parameter T and are not barred from attempting access to the wireless communications network based on a second different value of the parameter T.

17. The method in claim 16, wherein when the first value is zero and the second value is infinity.

18. The method in claim 16, further comprising sending or receiving the parameter T and an EAB flag, wherein the EAB flag indicates whether EAB is on or off.

19. The method in claim 1, wherein the determined access delay is determined based on a parameter T, the method further comprising:
initiating a barring timer for the UE;
if a value of the parameter T changes to a value less than a time remaining of the bar timer, the UE calculates a new delay for shortening the time for the UE to attempt to access the cell in the wireless communication network.

20. The method in claim 1, wherein the determined access delay is determined based on a parameter T, the method further comprising:
if the UE roams outside of its home wireless communication network, the UE calculates a roaming timer value based on the parameter T and a roaming factor.

21. The method in claim 1, wherein the determined access delay is a different value for different access classes, for different UEs, of for different operators.

22. The method in claim 1, wherein the determined access delay is determined based on a parameter T and the parameter T is based on a load in the cell or in the wireless communication network.

23. The method in claim 1, further comprising comparing the determined access time to a threshold, and if the determined access time exceeds the threshold, indicating that the UE is barred access to the cell, and if the determined access time is less than or equal to the threshold, indicating that the UE is not barred access to the cell.

24. Apparatus for controlling access of a user equipment, UE, to a wireless communication network, comprising electronic circuitry configured to:
determine an access delay for a UE configured for and activated to implement extended access barring, EAB, or included in a group of UEs addressed via group paging, and
control a timing of an attempt by the UE to access a cell in the wireless communication network based on the determined access delay.

25. The apparatus in claim 24, implemented in a network node in the wireless communication network, wherein the electronic circuitry further includes radio circuitry configured to broadcast the determined access delay in the cell.

26. The apparatus in claim 24, wherein the timing of the attempt is a random time less than the determined access delay but greater than zero.

27. The apparatus in claim 26, wherein the electronic circuitry is configured to generate a random number and calculate the access time by multiplying the random number by the determined access delay.

28. The apparatus in claim 24, wherein the electronic circuitry is configured to:
calculate a deterministic delay or delay component based on the determined access delay, and
use the deterministic delay or delay component to determine the timing of the attempt.

29. The apparatus in claim 28, wherein the electronic circuitry is configured to calculate the deterministic delay or delay component as a function of a UE identifier.

30. The apparatus in claim 29, wherein the electronic circuitry is configured to calculate the deterministic delay or delay component as a function of the UE identifier and an additional factor, A.

31. The apparatus in claim 30, wherein the additional factor A is one of: a secret key used for security in the UE, a per UE property, a commonly-known addition factor, a per UE class property, a system frame number, or a connection frame number.

32. The apparatus in claim 24, wherein the determined access delay is a time period over which access attempts to the wireless communications network from multiple UEs are spread out.

33. The apparatus in claim 24, wherein the electronic circuitry is configured to send or receive an EAB flag that indicates whether EAB is on or off.

34. The apparatus in claim 24, wherein the determined access delay is a different value for different access classes, for different UEs, or for different operators.

35. The apparatus in claim 24 implemented in the UE.

36. The apparatus in claim 24 implemented in a network node in the wireless communications network.
